(19) United States
(12) Patent Application Publication
(10) Pub. No.: US 2004/0001433 A1
(43) Pub. Date: Jan. 1, 2004

(54) Interactive control of network devices

(76) Inventors: Charles Andrew Gram, Santa Clara, CA (US); Marcus Wayne Ervin III, Scotts Valley, CA (US); Rob Mellencamp, Atherton, CA (US)

Correspondence Address: John C. Gorecki, Esq., 165 Harvard St., Newton, MA, 02460, US

(21) Appl. No.: 09/908,503

(22) Filed: Jul. 18, 2001

(51) Int. Cl. H04L 1/00

(52) U.S. Cl. 370/229; 370/401

(57) ABSTRACT

Methods and apparatus are disclosed for establishing interfaces or “tunnels” between networking devices, so one device can control the other and vice versa. Such devices may be general purpose processors (GPP) and ethernet web switches. A first device receives data packets as they flow across a network. A second device can access packets only if they flow through the first device. The second device can only send packets to the network if they flow through the first device. In a preferred embodiment, the first device is optimized for high-speed data transfer and the second device for data inspection and flow decision making. Each tunnel carries related types of packets in one direction between “partnered” devices. Data tunnels pass network data packets. Control tunnels carry messages to control the operation of a first device by a second. Messages stop, start or otherwise direct the flow of data through the first device. A Broadcast tunnel enables several network devices to interact. The second device contains logic that receives the data packets, processes them and sends them back to the first device. The second device can processing includes data inspection. and decision making based on the packet contents. A preferred embodiment blocks viruses including blocking intentional “Denial Of Service” schemes.

### FEDERALLY SPONSORED RESEARCH OR DEVELOPMENT

None.

### REFERENCE TO APPENDIX

An Appendix is included with this Specification which describes the structure of invention control interface, the various formats for identifying and addressing networking device partners and message payload structures.

1. Field of the Invention

The present invention relates to the field of networking devices, and to the control of one networking device by another. The invention addresses methods in which decisions are made by a first device affecting operational control of a second device. Alternatively, the invention pertains to methods in which a second device exerts control over the first—such as directing the flow of data through the first device for load-balancing or blocking “nefarious” viruses or intentional “denial of service” overloads.

More particularly, the invention provides a generalized interface architecture which is used for real time interactions between network switches and general purpose processors (GPP) for purposes of inspection and control of the flow of data to and from groups of GPP. The invention provides consistent, extensible, high-performance interfaces between groups of partnered processors, enabling the application of appropriate resources and providing a foundation for building network applications.

2. Background of the Invention

Combining applications with the other functions of a networking switching device (network switch) has been tried with varying degrees of success. Nortel Networks™ has manufactured and experimented extensively with such devices. These devices are referred to in this Specification as Nortel™ Appliances/Switch Architecture or “NA/SA.”

Certain applications have never been delivered within the constraints of a custom network processor. For example, in the case of encryption, it has not been viable to integrate hardware within a network switch. While commercial, off-the-shelf electronics are available, integration in a network switch combined with hardware in a GPP interferes with other network switch applications. In other cases, it is possible to make a suitable solution for a user's needs by large customization of network switch software coupled with a GPP running the user's application. But such a solution is essentially unique to that user.

It would be a major technological advance to provide a consistent framework for interfacing future interactive networking devices such as switches and GPPs; one which would:

1) be as efficient as possible, especially in terms of processing requirements and minimize the copying of Ethernet frames, allowing them to be processes “in-place;”

2) implement one interface and reuse it for each type of GPP product, leveraging switch and GPP development efforts and enabling a broad spectrum of GPP applications; and

3) reuse the same interface as network switches evolve.

Solving these problems would satisfy a long felt need of network user, network providers, and equipment manufacturers.

### SUMMARY OF THE INVENTION

The present invention provides apparatus and methods which establish a set of interfaces between a first networking device, for example, a general purpose processor (GPP) and a second networking device, for example, a network switch. By means of these interfaces, one device can control the other and vice versa. The first networking device is directly in the path of data packets as they flow across a network. It is most often optimized for high-speed data transfer. The second networking device is attached to the first, and can access packets only if they flow through the first device. Similarly, the second device can only send packets to the network if they flow through the first device. In a preferred embodiment, the second device is optimized for data inspection, and associated data flow decision making. In a preferred embodiment, network processing occurs in the network switch, and application processing occurs in the GPP.

The first device and second device are logically coupled by interconnections, referred to in this Specification as “tunnels.” Tunnels carry related types of packets in one direction between “partnered” network devices. To accomplish bi-directional data flow, the first device and second device are connected by two “data tunnels.”

Data tunnels are used to pass network data packets between network devices that are typically client-server in nature.

A Control tunnel is a special form of a tunnel that is used to control the operation of a first device by a second device. Messages are sent by the first device to exert control over the operation of the second device. These messages may exert operational control (start, stop, boot, etc) or data flow control. The data flow control messages are used to direct the flow of data through the device as described in the section below.

Another special form of tunnel is the Broadcast tunnel. All of the NA/SA enabled network devices can interact through this tunnel. These interactions can be similar to Control tunnel interactions. A Control tunnel exists between two network devices and a Broadcast tunnel exists between all network devices. A first device is configured to direct certain data flows to a second device through a first data tunnel. As data packets are received from the network by the first device, they are passed to the second device. The second device contains logic, typically in the form of an application program, that receives the data packets, processes them and then sends them back to the first device via a second data tunnel.

The second device can process the data packets in a number of ways. One type of processing is data inspection. The packets are viewed by the application program and can be recorded on an attached device, such as a hard drive. More complex processing by the application program makes decisions based on the contents of the packets. One preferred embodiment of application program is a virus checker. When the packets pass through the first device and arrive at the second device, the contents of the packets are classified and certain classes of packets are compared with known patterns. If the packets contain a matching pattern, then that packet, as well as all associated packets, are not sent back to the first device.

The second device establishes a Control tunnel with the first device. This tunnel is used to send control messages from the second device to the first device. The reverse process may also take place. The Control tunnel is also used to send responses to control message or unsolicited status messages from the first device to the second device. Various types of control messages can be:

(1) messages carrying command interface data to simulate user interaction with the first device such as start, stop and reboot; and/or

(2) data flow control messages that exert control regarding the flow of data packets through the first device; these messages change the configuration of the first device in such a way that new data packets arriving at the first device are directed or handled in the directed way.

This new configuration persists until the second device alters it with another control message or the first device's internal logic has determined that the change is appropriate.

When Data tunnels are used in conjunction with Control tunnels, another form of processing uses the contents of the data packets received at the second device to condition decisions regarding the subsequent flow of data packets through the first device. The control exerted by the second device on the first device can vary from blocking the flow of related data packets to accelerating the flow of data packets through the first device.

For example, when a known virus pattern is detected, the second device may block the flow of related packets from the first device. This limits the impact of a nefarious virus to the “data entrance” portion of the first device and the first device can efficiently handle data packets without requiring further use of the data tunnel or the second device.

In another embodiment, the application program scans the data flow for particular files of copyrighted material, such as might be transferred in file-sharing services such as Napster™. Fees could be assessed or the data blocked. One practiced in the art will note that this function can include blocking of intentional “Denial Of Service” schemes.

The first packets of a data flow can be examined and should the application program running on the second device be configured to route the flow of subsequent data packets, based on their contents, a route is chosen. The routing decision is conveyed to the first device via the Control tunnel, and the rest of the related data packets will flow through the first device without involving the second device. This method is called “Data Flow Acceleration.”

An appreciation of other aims and objectives of the present invention may be achieved by studying the following description of preferred and alternate embodiments and by referring to the accompanying drawings.

### A BRIEF DESCRIPTION OF THE DRAWINGS

FIG. 1 is a schematic diagram of a network showing a group of general purpose processors connected to a server farm and the Internet through a network switch.

FIG. 2 is a schematic of the internal structure of a general purpose processor.

FIG. 3 depicts, in schematic view, the general arrangement of networking devices which are partnered by an interface according to the present invention.

FIG. 4 is a schematic view showing the interactive logical connections or tunnels through which data and control signals are exchanged by partnered networking devices.

FIG. 5 reveals a schematic diagram of one embodiment of tunnel interconnections in which functions of a first networking device are coupled to functions of a second, partnered networking device, in this case a general purpose processor and a network switch, respectively.

### A DETAILED DESCRIPTION OF PREFERRED & ALTERNATIVE EMBODIMENTS

Introduction

The present invention provides an interface between networking devices such as an Alteon WebSystems™ Ethernet™ switch, and a general purpose processor (GPP) such as an Alteon WebSystems™ iSD (Integrated Service Director). Nortel Networks™ has manufactured and experimented extensively with such devices, and they are referred to in this Specification as Nortel™ Appliances/Switch Architecture or “NA/SA.” The architecture disclosed is intended to provide a consistent framework for future network switches and future GPPs.

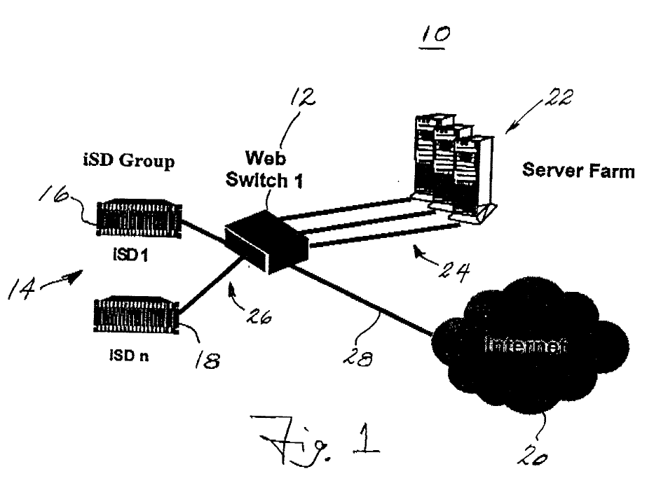

FIG. 1 shows schematically a typical network 10 in which a group 14 of general purpose processors (GPP) 16 & 18 which are connected 26 & 24 to a server farm 22, and coupled 28 to the Internet 20 through a network switch 12. Packet data flows between the networking devices 12, 16, 18, 22 and the Internet 20 through the network connections 26, 24 & 28.

In the present invention, a generalized interface is used to enable real-time interactions between the network switch 12 and GPPs 14. In some situations, the network switch 12 simply re-redirects the flow of data to the GPP group 14. In this situation, there is little need for control interactions between the network switch 12 and the GPP 16, 18. In other situations, the switch 12 is paired with a GPP 16 which views the initial portions of the flow of data. The GPP 16 then causes the network switch handle the rest of that particular connection. In this situation, the GPP 16 needs a control interface with the network switch 12 to change the future flow of data. The present invention addresses this need.

Interface Architecture

The foundation of the interface between a network switch 12 and a GPP 16, 18 is a message that contains an action or data. For switch control, the GPP 16, 18 sends control messages to a network switch management processor or one of the switch processors. For data control, the switch 12 encapsulates Ethernet frames and passes them to a GPP 16, 18. The GPP 16, 18 can send the updated encapsulated Ethernet frame back to the switch 12 for processing. Before exploring the details of these interactions, the following description of a GPP will be helpful to an understanding of the invention.

General Purpose Processor Structure

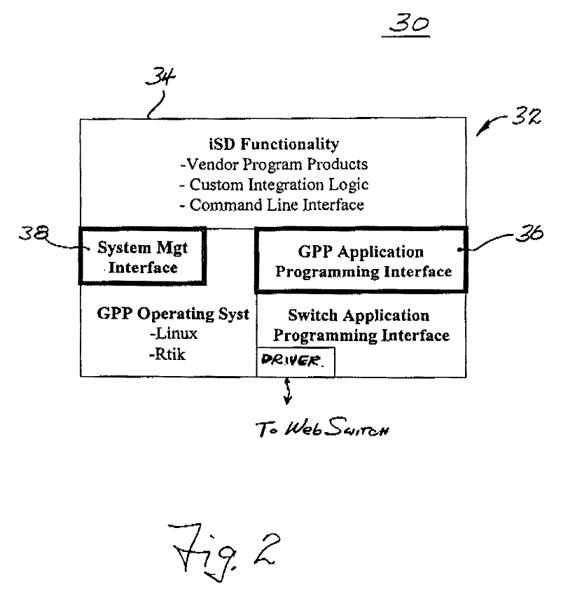

The internal structure 32 of the GPP is illustrated diagrammatically 30 in FIG. 2. Each different type of GPP used as an Integrated Service Director (iSD), is unique in only the iSD functionality area 34 containing vendor program products, custom integration logic and the command line interface. The iSD Functionality area 34 may contain vendor program products or application programs that implement custom logic. In either case, there will usually be some integration logic that couple it with the GPP environment. This logic will either call the GPP operating system or invoke the GPP Application Programming Interface (GPP API) 36. The GPP will also contain a System Management Interface component 38 that enables a systems management process to control the GPP.

The GPP API 36 is an application view of the GPP's partner, either another GPP 16, 18 or a network switch 12. For example, a function named “add₁₃ user₁₃ to₁₃ video₁₃ stream ( )” might be available. A set of control messages that are generated by the GPP Application Programming Interface would contain actions that would accomplish the desired function. This set of messages would be passed along to the appropriate driver. The driver would modify each message, if required, to suit the needs of the attached switch 12 or GPP 16, 18.

Preferred & Alternative Embodiments

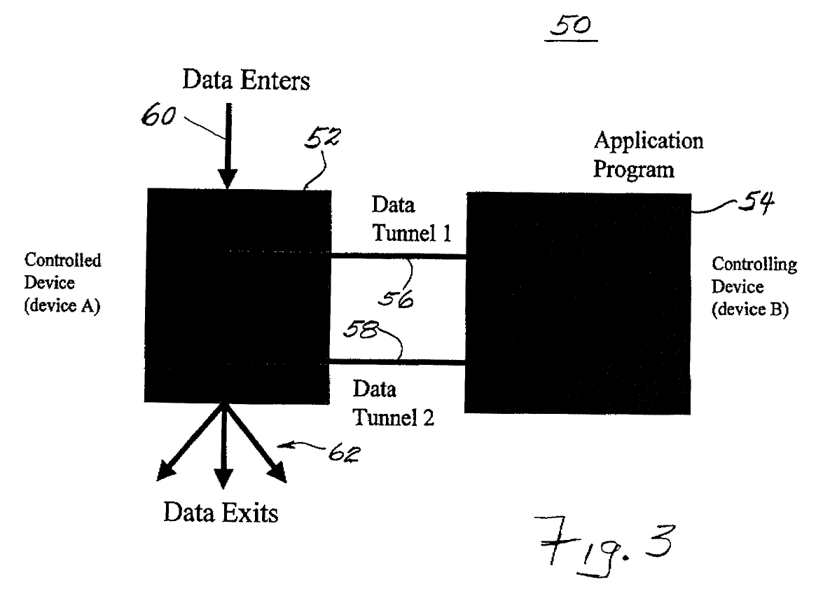

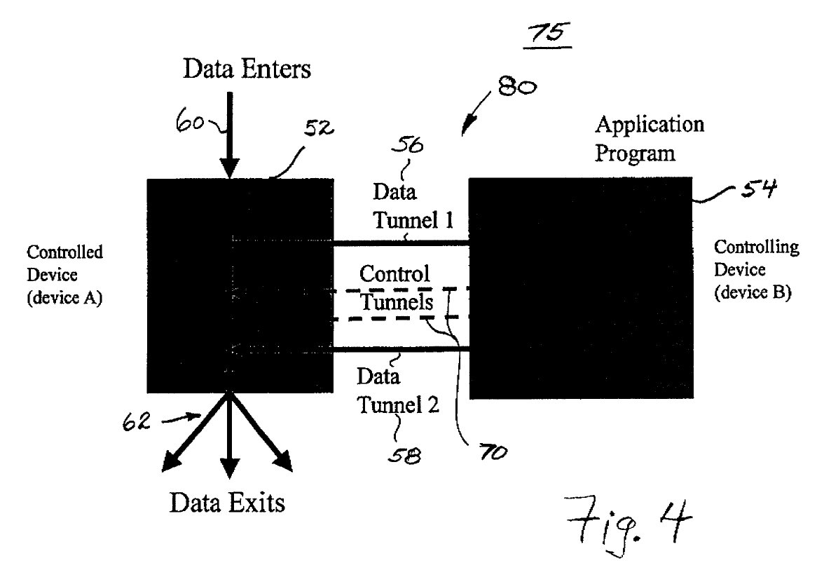

FIGS. 3 and 4 depict, in schematic view, the general arrangement of networking devices 52 & 54 which are “partnered” by an interface according to the present invention. FIG. 3 describes the flow of data 60 through two partnered devices 52 & 54. FIG. 4 shows the interactive logical connections or “tunnels” 56, 58, 70 through which data and control signals are exchanged by the partnered networking devices 52 & 54. The first device 52 and second device 54 are logically coupled by these tunnels. Each data tunnel 56, 58 carries related types of packets in one direction between the partnered network devices 52 & 54 resulting in bi-directional data flow.

For convenience, the tunnels 56, 58, 70 have been divided into their special uses. Data tunnels 56, 58 are used to pass network data packets between network devices that are typically client-server in nature. Data tunnels are discussed in more detail in a section below.

A Control tunnel 70 is a special form of a tunnel that is used to control the operation of a first device 52 by a second device 54. Messages are sent by the first device 52 to exert control over the operation of the second device 54. These messages may exert operational control (start, stop, boot, etc) or data flow control. The data flow control messages are used to direct the flow of data 60 through the device as described below.

Another special form of tunnel is the Broadcast tunnel. All of the NA/SA enabled network devices can interact through this tunnel. These interactions are similar to Control tunnel 70 interactions. The primary difference between the Control and Broadcast tunnels is that a Control tunnel 70 exists between two network devices 52 & 54 and a Broadcast tunnel exists between all network devices 14.

Data Tunnel

A first device 52 is configured to direct certain data flows 60 to a second device 54 through a first data tunnel 56. As data packets are received from the network by the first device 52, they are passed to the second device 54. The second device 54 contains logic, typically in the form of an application program, that receives the data packets, processes them and then sends them back to the first device 52 via a second data tunnel 58.

The second device 54 can process the data packets in a number of ways. One type of processing is data inspection. In this form, the packets are viewed by the application program and can be recorded on an attached device, such as a hard drive. More complex processing by the application program makes decisions based on the contents of the packets. When the packets pass through the first device 52 and arrive at the second device 54, the contents of the packets are classified and certain classes of packets are compared with known patterns. If the packets contain an undesirable, matching pattern, then that packet, as well as all associated packets, are not sent back to the first device 52. These data packets are termed “dropped packets.” If the data packets are not blocked, they may be further processed in the first device 52 and sent back 62 to the network.

Control Tunnel

The second device 54 establishes a Control tunnel 70 with the first device 52. The Control tunnel 70 is used to send control messages from the second device 54 to the first device 52. The reverse process may also take place. The Control tunnel 70 is also used to send responses to control message or unsolicited status messages from the first device 52 to the second device 54. Various types of control messages are possible:

(1) messages carrying command interface data which simulate user interaction with the first device 52—these messages are typically used to exert operational control over the first device 52, such as start, stop and reboot; and/or

(2) data flow control messages that exert control regarding the flow of data packets through the first device—these messages change the configuration of the first device in such a way that new data packets arriving at the first device are directed or handled in the directed way. This new configuration persists until the second device alters it with another control message or the first device's internal logic has determined that the change is appropriate.

Data Flow Control

When Data tunnels 56 & 58 are used in conjunction with Control tunnels 70, then another form of processing can occur beyond that described above. This form of processing uses the contents of the data packets received at the second device to condition decisions regarding the subsequent flow of data packets through the first device. The control exerted by the second device on the first device can vary from blocking the flow of related data packets to accelerating the flow of data packets through the first device.

In a virus scanning application program, for example, when a known virus pattern is matched, the second device 54 may block the flow 60 of related packets from the first device 52. This has the advantage of limiting the impact of a nefarious virus to the “data entrance” portion of the first device and the first device can efficiently handle data packets without requiring further use of the data tunnel or the second device.

In another embodiment, the application program scans the data flow for particular files of copyrighted material, such as might be transferred in file-sharing services such as Napster™. Fees could be assessed or the data blocked. One practiced in the art will note that this function can include blocking of intentional “Denial Of Service” schemes.

The first packets of a data flow are examined. Should the application program running on the second device 54 be configured to route the flow of subsequent data packets, based on their contents, a route is chosen. The routing decision is conveyed to the first device 52 via the Control tunnel 70 and the rest of the related data packets will flow through the first device 52 without involving the second device 54. Logical View of a Network Switch/GPP System

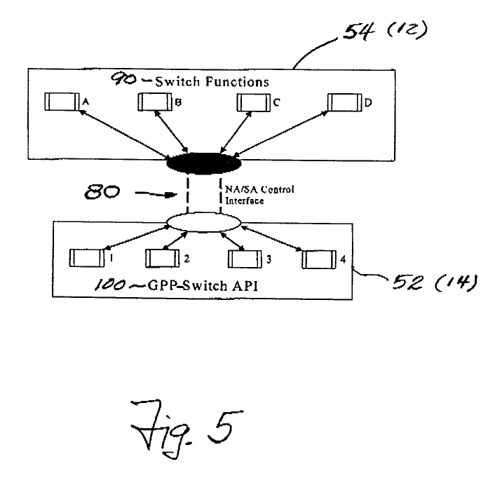

Since the GPP 16, 18 and network switch 12 have a logical view, represented by their respective APIs, then the combination of network switch 54 (12) and GPP 52 (14) is properly considered a system. As seen in FIG. 5, the invention interface 80 allows the GPP-Switch API 100 to access functions 90 within the network switch 54 (12). Conversely, the network switch functions 90 can access GPP functions 100. For example, GPP function 100₁ can be linked to Switch function 90_{A}.

### APPENDIX

NA/SA Tunnels

1. Tunnel Concepts

Tunnels are logical conduits between two NA/SA partners (network switches or GPPs). A 16-bit tunnel ID is associated with each tunnel. Tunnels are unidirectional, since one partner writes to it and the other partner reads from it. In the case, where each partner reads from and writes to the same tunnel ID, there are logically two unidirectional tunnels. Thus, tunnels should always be considered unidirectional.

The eth₁₃ type field of each Ethernet frame that traverses a given tunnel contains that tunnel's ID value. Tunnel IDs are assigned such that the eth₁₃ type is symmetrically transformed. This means that the value of eth₁₃ type at the entrance to the tunnel can be reconstructed at the exit end of the tunnel.¹ As an example, an IP Ethernet frame could be sent through the IP₁₃ DATAGRAM tunnel and transformed back into an IP frame at the other end. 1. As this architecture is incorporated in other network switches and Special Purpose Processors (SPPs), there may be changes. As an example, the implementation of a tunnel may not depend on Ethernet frames. In that situation, a suitable mechanism is substituted.

At the tunnel exit, the tunnel ID is the primary basis to determine the disposition of each Ethernet frame. The network switch and the GPP will provide a mechanism to associate an application with each of its supported tunnels. If Ethernet frames are received for a tunnel ID that is not supported, then the recipient will drop all of those frames.

Transmission of Ethernet frames through a tunnel is on a best effort basis, except for the control tunnel. If reliable transport is required by an application, then it is the application which will provide it. Since the very nature of the control tunnel makes each interaction critical, then special provisions are made for that tunnel as described below in paragraph 14.

2. Frame Formats

In an Ethernet frame, the Ethernet header is followed by the payload, which is followed by the frame checksum (CRC). The Frame header is described in the next section. For Ethernet frames that traverse a NA/SA tunnel, the format of the payload is indicated in Table A. The details of these formats are:

a. NA/SA message header followed by the message body as described in paragraph 14.

b. The original payload is unchanged. Only the Ethernet header is changed.

3. Frame Header

All Ethernet frames that traverse NA/SA tunnels have a frame header and payload. The frame header always has the same structure. The only difference, between the various tunnel s frame headers, is the value of the Eth₁₃ type field. Every frame will specify the partner's destination address, the sender's address as the source address and one of the types specified in Table B. The structure of the frame header is as follows:

TABLE A
Frame Header Structure

| NA/SA Header | | |
|---|---|---|
| Field Name | Data Type | Value |
| Destination MAC | U8 (6) | NA/SA partners destination Hardware |
| Source MAC | U8 (6) | NA/SA source Hardware Address |
| Eth_type | U16 | The NA/SA tunnel identifier-ties this |
| | | frame to a specific NA/SA tunnel. |

4. Addressing

All identification of NA/SA partners is accomplished by hardware addresses, which are commonly referred to as MAC addresses. The Source MAC address identifies the sender of an Ethernet frame and the Destination MAC address identifies the intended recipient. This applies to all NA/SA tunnels.

TABLE B
Recognized Tunnel ID's

| Tunnel ID | Format | Description |
|---|---|---|
| NA/SA_TUNNEL_ARP_PACKET | 2 | Used to pass Address resolution |
| | | Protocol Packets |
| NA/SA_TUNNEL_BROADCAST | 1 | Used to pass NA/SA broadcast |
| | | messages. See para. 15. |
| NA/SA_TUNNEL_CLIENT_REDIRECT | 2 | Used to pass an IP datagram |
| | | that contains an application- |
| | | level redirect directive to |
| | | the indicated IP address. |
| NA/SA_TUNNEL_CONTROL | 1 | Used for control interactions |
| | | between NA/SA partners. |
| | | See para. 14. |
| NA/SA_TUNNEL_FIREWALL | 2 | Used to pass IP datagrams |
| | | among firewall partners. |
| NA/SA TUNNEL_IP_DATAGRAM | 2 | Used to pass IP datagrams² |
| NA/SA_TUNNEL_IP_FRAGMENT | 2 | Used to pass IP datagram |
| | | fragments between NA/SA |
| | | partners |
| NA/SA_TUNNEL_IP_REDIRECT | 2 | Used to pass an IP datagram |
| | | and to cause all subsequent |
| | | associated datagrams to flow |
| | | to the indicated IP address, |
| | | different than the original |
| | | IP address (or port). |
| NA/SA_TUNNEL_MAC_FORWARD | 2 | Used to pass Ethernet frames |
| | | with the intent that the en- |
| | | closed Ethernet frame be for- |
| | | warded based on its MAC |
| | | information. |

²These diagrams are typically flowing between clients and servers, such as a web browser and web server. This tunnel is used to divert the data flow to facilitate one of the following; Data Transformation, Decision Export and Auxiliary Services. Examples include, content manipulation or insertion, server load balancing based on business logic and messaging services.

5 ARP PACKET Tunnel

The ARP Packet Tunnel is used to pass Address Resolution Protocol packets between NA/SA partners. The NA/SA header must have:

Eth₁₃ type=NA/SA₁₃ TUNNEL₁₃ ARP₁₃ PACKET

The structure of the payload of Ethernet frames traversing this tunnel is described in the following table:

TABLE C
ARP Packet Frame Structure

| Payload Field | | |
|---|---|---|
| Name | Data Type | Value |
| ARP Packet | U8 (n) | The ARP packet that is being passed |

6. BROADCAST Tunnel

The Broadcast Tunnel is used to pass broadcast messages amongst NA/SA partners. The details of the Broadcast Message field are provided in Chapter 5. The NA/SA header must have:

Eth₁₃ type=NA/SA₁₃ TUNNEL₁₃ BROADCAST.

The structure of the payload of Ethernet frames traversing this tunnel is described in the following table:

TABLE D
Broadcast Message Frame Structure

| Payload Field | | |
|---|---|---|
| Name | Data Type | Value |
| Broadcast Message | U8 (n) | The message that is being broadcast as |
| | | described in section 15. |

7. CLIENT REDIRECT Tunnel

The Client Redirect Tunnel causes the network switch to send an IP datagram back to the client. The datagram contains a redirect directive that is appropriate for the specified IP protocol. The NA/SA header must have:

Eth₁₃ type=NA/SA₁₃ TUNNEL₁₃ CLIENT₁₃ REDIRECT.

The structure of the payload of Ethernet frames traversing this tunnel is described in the following table.

TABLE E
Client Redirect Directive Frame Structure

| Payload Field Name | Data Type | Value |
|---|---|---|
| Datagram | U8 (n) | The IP datagram that is being passed |

8. CONTROL Tunnel

The Control Tunnel is used to influence the actions of a network switch or GPP. The details of the NA/SA Message field are provided in paragraph 14. The NA/SA header must have:

Eth₁₃ type=NA/SA₁₃ TUNNEL₁₃ CONTROL.

The structure of the payload of Ethernet frames traversing this tunnel is described in the following table.

TABLE F
NA/SA Message Frame Structure

| Payload Field Name | Data Type | Value |
|---|---|---|
| NA/SA Message | U8 (n) | This field contains NA/SA messages |
| | | as described in section 14. |

9. FIREWALL Tunnel

The Firewall Tunnel is used to pass IP datagrams and related switch internal information between NA/SA partners. The information regarding the internal switch element, such as Switch Port or IP Interface, is passed in an encoded form of the Source MAC address (SMAC). The NA/SA header must have:

Eth₁₃ type=NA/SA₁₃ TUNNEL₁₃ FIREWALL

The structure of the payload of Ethernet frames traversing this tunnel is described in the following table.

TABLE G
Source MAC Address Frame Structure

| Payload Field Name | Data Type | Value |
|---|---|---|
| Datagram | U8 (n) | The IP datagram that is being passed |

10. IP DATAGRAM Tunnel

The IP Datagram Tunnel is used to pass IP datagrams between NA/SA partners. The NA/SA header must have:

Eth₁₃ type=NA/SA₁₃ TUNNEL₁₃ IP₁₃ DATAGRAM.

The structure of the payload of Ethernet frames traversing this tunnel is described in the following table.

TABLE H
IP Datagram Frame Structure

| Payload Field Name | Data Type | Value |
|---|---|---|
| Datagram | U8 (n) | The IP datagram that is being passed |

Example of usage: re-direct filter on network switch sends an Ethernet frame to a GPP via the IP Datagram Tunnel

a. The network switch receives an Ethernet frame that matches the filter criteria and updates the Ethernet header as described above.

b. The SP sends the message via the IP Datagram Tunnel.

c. The GPP receives the Ethernet frame via the IP Datagram Tunnel and passes it to the Request consumer.

d. The Request consumer transforms the contents of the IP datagram.

e. The GPP sends the IP datagram to the IP Datagram Tunnel handler. The IP datagram is sent to the network switch via the IP Datagram Tunnel.

f. The SP receives the IP Datagram frame, which passes it to the Request consumer.

g. The Request consumer queries the IP datagram and forwards it to the updated IP Address.

11. IP FRAGMENT Tunnel

The IP Fragment Tunnel is used to pass IP datagrams, which contain IP fragments, between NA/SA partners.

The NA/SA header must have:

Eth₁₃ type=NA/SA₁₃ TUNNEL₁₃ IP₁₃ FRAGMENT.

The structure of the payload of Ethernet frames traversing this tunnel is described in the following table.

TABLE I
IP Fragment Datagram Frame Structure

| Payload Field Name | Data Type | Value |
|---|---|---|
| Datagram | U8 (n) | The IP datagram that is being passed |

12. IP REDIRECT Tunnel

The IP Redirect Tunnel causes the network switch to update associated tables with new values from the IP datagram (update IP address, or the TCP/UDP port, or both) and then sends the IP datagram to the specified destination. All subsequent frames for this session will also flow to this destination. The NA/SA header must have:

Eth₁₃ type=NA/SA₁₃ TUNNEL₁₃ IP₁₃ REDIRECT.

The structure of the payload of Ethernet frames traversing this tunnel is described in the following table:

TABLE J
IP Redirect Frame Structure

| Payload Field Name | Data Type- | Value |
|---|---|---|
| Datagram | U8 (n) | The IP datagram that is being passed |

13. MAC FORWARD Tunnel

The Forward to MAC Tunnel causes the network switch to forward an Ethernet frame to the destination MAC address of the enclosed frame. Note that the Destination MAC address of this Ethernet frame can be used to address a specific element within a network switch. Additionally, the Source MAC address of the frame to be forwarded can be used to indicate the desired routing within the network switch. The NA/SA header must have:

Eth₁₃ type=NA/SA₁₃ TUNNEL₁₃ MAC₁₃ FORWARD.

The structure of the payload of Ethernet frames traversing this tunnel is described in the following table.

TABLE K
MAC Forward Frame Structure

| Payload Field Name | Data Type | Value |
|---|---|---|
| Ethernet Frame | U8 (n) | The Ethernet frame to be forwarded |

14. NA/SA CONTROL Tunnel

The NA/SA control tunnel is used to pass NA/SA messages between partners. NA/SA messages can be broken down into two classes of functions; System-level Control and Table Manipulation. In most cases, invoking one of these functions will cause an Ethernet frame to flow between the GPP and its partner, either a network switch or a GPP. A message will flow and data may be returned. In rare cases, invoking one of these functions will simply reference information that was previously cached in the GPP.

A NA/SA message is comprised of sections. The Link Layer section is required to be the first section of every NA/SA message. The message Header section follows the Link Layer section and is required in every NA/SA message. The message body follows the Header section. The contents of the message body are dependent on the value of the Type and Modifier fields of the message Header. Some message types do not have a message body.

14.1 Link Layer Section

The first section of each NA/SA message is the Link Layer Section. This section is required in every message. It must be the first section of the message and is built by the NA/SA message transport functions (described in paragraph 19).

TABLE L
Link Layer Frame Structure

| | Data | |
|---|---|---|
| Field Name | Type | Value |
| Version | U8 | NA/SA_VERSION 1 |
| Pad | U8 | Reserved for future use. This field must be 0 |
| ACK Required | U1 | Indicates that the message sender requires a |
| | | link-level ACK message from the message |
| | | recipient. |
| LL Flags | U15 | Reserved for future use. These bits must be |
| | | zero. |
| Sequence Number | U16 | If ACK Required is TRUE, then this field |
| | | contains an ever-increasing number that |
| | | indicates the ordering and sequencing of |
| | | NA/SA messages. This number is echoed back |
| | | in the link-level ACK message. If ACK |
| | | Required is FALSE, then this field must |
| | | contain zeros. |
| Message Length | U16 | The length of the payload. This value does |
| | | NOT include the length of the Link Layer |
| | | section |
| Checksum | U16 | The 16 bit one's complement of the one's |
| | | complement sum of all 16-bit words in the |
| | | payload. If the Message Length contains an |
| | | odd value, then zeroes will be padded to the |
| | | end of the payload for this calculation. The pad |
| | | is not transmitted as part of the payload. This |
| | | algorithm is specified in RFC1071. |

14.2 Message Header Section

The second section of each NA/SA message is the message Header Section. This section is required in every message. It must immediately follow the Link Layer Section and identifies the purpose of the message. The structure of this section is described in the following table.

TABLE M
Message Header Frame Structure

| Field Name | Data Type | Value |
|---|---|---|
| Header | U8 | NA/SA_HEADER_VERSION1 |
| Security Type | U8 | Indicates the security algorithm that was |
| | | used to encrypt the rest of the message from |
| | | this point on. The message Header fields that |
| | | precede this field are not subject to |
| Service Units | U1 | Indicates that the Service Units Used field |
| | | contains |
| Request | U1 | Indicates that the application considers this |
| Message | | message to be a request. If TRUE, the |
| | | application requires a response message in |
| | | which the Message Identifier field contains |
| | | the same value as this Request Message. |
| Response | U1 | Indicates that the application considers this |
| | | message to |
| Header Flags | U12 | Reserved. This field must contain zeros. |
| Type | U8 | This field contains a value, which may be |
| | | conditioned by the Modifier field that |
| | | indicates the format of the message body and |
| | | the purpose of the message. |
| Modifier | U8 | This field can be used to indicate a modifica- |
| | | tion of the Type field. If the Type field is not |
| | | being modified, then this field shall contain |
| | | zero. |
| Response | U16 | This field shall contain zero in all request |
| Code | | messages. If, during the processing of a |
| | | request, an error was encountered then this |
| | | field of the response message will contain |
| | | the error indicator (one of the NA/SA_{—} |
| | | ERROR_xxxxx values) as defined in |
| | | Appendix B. If there was an exception |
| | | condition encountered during the delivery |
| | | of a NA/SA message, then a NA/SA_{—} |
| | | EXCEPTION message is formed with this |
| | | field set with an exception indicator (one of |
| | | the NA/SA_EXCEPTION_xxxx values) |
| | | as defined in Exception Numbers paragraph |
| | | below |
| Message | U32 | A number assigned by the requestor and |
| Identifier | | echoed back in a response message |
| Service Units | U32 | If the Service Units Reported flag is true, |
| Used | | then this field used to report the current |
| | | utilization of a GPP. A network switch can |
| | | base its load balancing decisions on this |
| | | field. If the Service Units Reported flag is |
| | | not true, then this field shall contain zeros. |

14.3 Message Exception Handling

There are two defined classes of NA/SA message exceptions: Type and Data. A Type exception is indicated when the Message Header Type field contains a value that is not supported. A Data exception is indicated when a field contains illogical data, such as all fields of a Session Create message body contains zeros or all bits in an Applicable field are 0.

As the network switch (or GPP) is processing a request message, it is possible to have an error. In the general case, the error is logged via an appropriate mechanism for that device. If there is a response message defined for this request message, then the request message is converted into a Response Message by recording an error code in the Response Code field of the message header and sending the message back to the message originator. The message originator is responsible for undoing any damage that the exception may have caused, such as inconsistent data in switch tables.

For certain exception circumstances (usually related to message reception), it is useful to provide an indication to another NA/SA entity. In these cases, a NA/SA₁₃ EXCEPTION message is formed. The Header Type field is set to NA/SA₁₃ EXCEPTION, the Response Code field is assigned a relevant value, and the message body is comprised of the offending message (message Header and message body). Then the message is sent as an unacknowledged message. It is expected (but not required) that all NA/SA exception routines reference Houston, as in “Houston, we have a problem.”

14.4 Applicable Field

Some of the fields contained within a Control message aren't always relevant. The technique that is used to determine when a field is relevant is to associate a validity bit with each field in a frame. The validity bits are accumulated into a U16 field named Applicable. This implies that, while processing a Control message that contains an Applicable field, the process should test the associated bit before using the data values provided in the message body.

Throughout this document, whenever a Control message contains an Applicable field, the definition of each field will have an associated applicable bit number. There are a set of defined symbols of the form NA/SA₁₃ APPLICABLE₁₃ BITn, where n ranges from 0 to 15. These defined symbols should be used to perform the field validity test described above.

14.5 Control Message Transport

The NA/SA Link Layer section determines the manner in which message delivery is handled. The control tunnel uses a best-efforts approach to message delivery, unless the ACK Required flag in the Link Layer section is true. When ACK Required is true, then the application has requested reliable message delivery. Using the Sequence Number field of the Link Layer section and the use of link-level ACK messages assure reliable delivery. The details of reliable message delivery are provided in the next sections.

14.6 Link-level ACK Message

The reliable message delivery process requires the transmission of a link-level ACK message. When the NA/SA transport layer of a NA/SA partner receives a message that has the ACK Required flag set to true, then a link-level ACK message must be generated. A single ACK message can acknowledge multiple messages. Thus, if an ACK message is dropped, then a subsequent ACK message will acknowledge more than one message.

A link-level ACK message is comprised of only a Link Layer section. The Link Layer section contains the following:

| | |
|---|---|
| a. | The Version field is set to NA/SA_VERSION1. |
| b. | The Pad field is set to zero. |
| c. | The ACK Required flag is false. |
| d. | Set the Sequence Number field to the Sequence Number that is being |
| | acknowledged. |
| e. | The Message Length field is set to 0. |
| f. | The Checksum field is set to x ‘FFFF’. |

14.7 Message Transmission

The following three processes are used to deliver NA/SA control messages. The first process describes best effort transmission. The second and third processes are used for providing reliable delivery of NA/SA control messages:

a. NA/SA₁₃ MSG₁₃ SEND

The ACK Required field is set false, Sequence Number is set to 0, and Checksum is calculated.

The message is sent and control returns to caller.

b. NA/SA₁₃ MSG₁₃ SEND₁₃ WITH₁₃ ACK

The next sequential Sequence Number value is generated and set in the Link Layer section. The ACK Required field is set true and Checksum is calculated.

If there are messages on the deferred queue or there is more than the predefined OUTSTANDING₁₃ WINDOW number of messages on the outstanding queue, then add this message to the end of the deferred message queue and return to caller.

Else send the message. Then add it to the end of the outstanding queue and return to caller.

c. NA/SA₁₃ MSG₁₃ SEND₁₃ REDRIVE (periodically invoked and explicitly invoked by NA/SA₁₃ MSG₁₃ RECEIVE process).

Send the messages that are on the deferred queue. This must be done in order by Sequence Number field of the message header.

If there is more than the predefined OUTSTANDING₁₃ WINDOW number of messages on the outstanding queue, then exit.

14.8 Message Reception

Ethernet frames with an Eth₁₃ type of NA/SA₁₃ TUNNEL₁₃ CONTROL are received at the exit of the NA/SA control tunnel. If reliable message delivery is indicated (by ACK Required being set true), then the NA/SA₁₃ MSG₁₃ RECEIVE process generates a link-level ACK as described in section 14.6 The higher-level NA/SA functions only allow one Request message consumer to be identified. Thus, NA/SA₁₃ MSG₁₃ RECEIVE simply passes Requests along to that consumer. The algorithm for handling message reception is:

A. NA/SA₁₃ MSG₁₃ RECEIVE

1. Receive a message.

2. Calculate the checksum of the message and compare to Checksum field of Link Layer section. If they differ, increment a counter and free the message.

3. If the Message Length is zero (this is a link-level ACK),

a. If the Sequence Number of the link-level ACK message is less than the Sequence Number of the first message on the outstanding queue, free the link-level ACK message and no further action will be taken.

b. For each message on the outstanding queue whose Sequence Number is less than or equal to the Sequence Number of the link-level ‘ACK message’,

i. De-queue the message from the outstanding queue.

ii. Free the message.

c. Free the link-level ACK message.

d. If there are any messages on the deferred queue, invoke the NA/SA₁₃ SEND₁₃ MSG₁₃ REDRIVE process.

e. No further action will be taken.

4. If the message has the ACK Required flag set,

a. If there are not sufficient resources to allow the message to be retained, then increment a counter and free the message. No further action will be taken.

b. If the Sequence Number of the message does not contain the Link Layer Expected Value,

i. If the Sequence Number of the message is less than the Expected Value, then generate and send a link-level ACK message as described in section 14.20 with a Sequence Number of the Expected Value minus one.

ii. Increment a counter and free the message.

iii. No further action will be taken.

c. Generate a link-level ACK message as described in paragraph 14.6 with a Sequence Number of the Expected Value.

d. Increment the Link Layer Expected Value.

e. Send the ACK message via NA/SA₁₃ MSG₁₃ SEND.

f. Continue with message processing.

5. If a Request consumer has not been identified,

a. Form a NA/SA₁₃ EXCEPTION message and send it via NA/SA₁₃ MSG₁₃ SEND.

b. Increment a counter and free the message.

6. If the Request consumer is not prepared to receive the message, retain the message are indicate to the consumer that messages are available.

7. When the Request consumer is prepared to receive a message, then pass along the oldest message.

14.9 Structure of a Control Message

An NA/SA control message is comprised of a Link Layer section, Message Header section and (optionally, depending on the message Type and Modifier) the message body with one request or response. Each message body contains data fields as required. The data field contents vary based on the message type. All data contained in a message are in network byte order.

An example of a message that would add a session table entry could contain the following (details will be explained later in this Appendix):

[image]

[image]

14.10 Response Messages

This class of messages is used to pass data among network switches and GPPs. This data is primarily of a control nature, such as the values that comprise a session table entry.

All response messages have the same structure: Link Layer section, message Header section followed by the relevant message body. The Request Message flag is always FALSE and the Response Message is always TRUE for a response message. The supported message types are summarized in the following table and details are provided in subsequent sections.

TABLE N
Message Header Frame Structure

| Message Type | Message Modifier | Description |
|---|---|---|
| NA/SA_CMD_RESULTS | NA/SA_LOCK_OWNED or | Contains the results of a |
| | NA/SA_LOCK_NOT_OWNED | CLI request |
| NA/SA_HEARTBEAT | 0 | Provides feedback |
| | | regarding a heartbeat |
| | | request. |
| NA/SECESSION | NA/SA_CHARACTERISTICS | Characteristics of the |
| | | session table |
| NA/SECESSION | NA/SA_ENTRY | Session table entry values |
| | | for a given session, |
| | | typically between a client |
| | | and server |
| NA/SECESSION | NA/SA_FEEDBACK | Optional Session table |
| | | manipulation response |
| | | message |

4.11 Command Results

The Command Results response message is used to return the results of a CLI request. The following message Header fields must have the following values:

Request Message=FALSE

Response Message=TRUE

Type=NA/SA₁₃ CMD₁₃ RESULTS

Modifier=NA/SA₁₃ LOCK₁₃ OWNED or NA/SA₁₃ LOCK₁₃ NOT₁₃ OWNED indicating the current status of the command lock

Message Identifier=Message Identifier value from request message The structure of this message body is described in the following table. The length of the message is set in the Message Length field of the Link Layer section.

A series of messages with Response Code of NA/SA₁₃ CLI₁₃ STATUS will always be followed by a message with a Response Code of NA/SA₁₃ ERROR₁₃ CLI₁₃ FAIL to allow detailed error messages to be passed between NA/SA entities. If this is a multi-message successful response, then the sender can indicate message order by the Sequence Number field. The first through the next-to-last message will have Response Code=NA/SA₁₃ SUCCESS and the last message is indicated by Response Code=NA/SA₁₃ SUCCESS₁₃ LAST.

TABLE O
Command Results Response Message Frame Structure

| Message Body Field Name | Data Type | Value |
|---|---|---|
| Sequence Number | U32 | A field that allows a CLI handler |
| | | to indicate the order of CLI |
| | | results to the requestor so that |
| | | the requestor can re-construct |
| | | the entire command result. |
| Command Result Text | U8 (n) | The text results of a CLI |
| | | command |

Example of usage: Network switch sends a CLI command to a GPP

1. The Message Processor identifies that the user has entered a command that is to be handled by a GPP.

2. The Message Processor forms a message with Request Message=TRUE, Response Message=FALSE, a Type=Command and Modifier=0

3. The MP sends the message via NA/SA₁₃ MSG₁₃ SEND₁₃ WITH₁₃ ACK.

4. The GPP receives the message via NA/SA₁₃ MSG₁₃ RECEIVE and passes it to the Request consumer.

5. The GPP Request consumer calls the CLI command handler with the command.

6. The GPP forms a message with Request Message=FALSE, Response Message=TRUE, Type=Command Results, Modifier=NA/SA₁₃ LOCK₁₃ NOT₁₃ OWNED -and Message Identifier field equal to the Message Identifier in the Request message.

7. The GPP sends the Command Results message via NA/SA₁₃ MSG₁₃ SEND₁₃ WITH₁₃ ACK.

8. The MP receives the Command Results message via NA/SA₁₃ MSG₁₃ RECEIVE.

9. The results of the command are displayed to the user.

In Unusual Conditions:

a) The command is not recognized by the GPP: The normal processing is followed with the exception that the Command Results message contains text that describes the error and provides user help for valid commands.

b) A command is passed that requires that the command lock be owned: The Command message is not executed, a Command Results response message is formed with the Response Code set to:

NA/SA₁₃ ERROR₁₃ CMD₁₃ LOCK₁₃ NOT₁₃ OWNED.

14.12 Heartbeat Response

The Heartbeat Response message is used to acknowledge a Heartbeat Request message. The following message Header fields must have the following values:

| Request Message = | FALSE |
|---|---|
| Response Message = | TRUE |
| Type = | NA/SA_HEARTBEAT |
| Modifier = | 0 |

There is no message body for a Heartbeat Response message, therefore the Message Length field of the Link Layer section is always set to the length of the message Header.

NA/SA Heartbeat Response messages are always sent best effort.

14.13 Session Characteristics

The Session Characteristics response message is used to return characteristics of the session table to the requester. The following message Header fields must have the following values:

| | |
|---|---|
| Request Message = | FALSE |
| Response Message = | TRUE |
| Type = | NA/SECESSION |
| Modifier = | NA/SA_CHARACTERISTICS |

The structure of this message body is described in the following table. The length of the message is set in the Message Length field of the Link-Layer paragraph.

TABLE P
Session Characteristics Response Frame Structure

| Message Body | Data | Value |
|---|---|---|
| Valid Session | U16 | The number of valid session entries in the |
| Entries | | session table |
| Session Entry Size | U16 | The number of bytes in a session entry |
| Session Table Size | U32 | The number of bytes in the session table |

Example of usage: GPP needs the characteristics of the session table that resides in an associated network switch:

1. The GPP forms a message with Request Message=TRUE, Response Message FALSE, Type=Session and Modifier=Characteristics.

2. The GPP sends the Request message via NA/SA₁₃ MSG₁₃ SEND₁₃ WITH₁₃ ACK

3. An SP receives the Request message via NA/SA₁₃ MSG₁₃ RECEIVE, which passes it to the Request consumer.

4. The Request consumer counts the number of valid entries in the session table.

5. The Request consumer forms an Session Characteristics Response message with the Valid Session Entries field equal to the count from step 4, the Session Table Size field is set to a constant, and the Session Entry Size field is also set to a constant. The Message Identifier in the header of the Response message must equal the Message Identifier in the Request message. The Request Message flag is set FALSE and the Response Message flag is set TRUE.

6. The SP sends the Response message via NA/SA₁₃ MSG₁₃ SEND₁₃ WITH₁₃ ACK.

7. The GPP receives the Response message, via NA/SA₁₃ MSG₁₃ RECEIVE, which notifies the NA/SA higher-level function of success.

8. The requestor is returned a Session Characteristics Response message.

14.14 Session Entry

The Session Entry response message is used to return the values from a session entry to the requester. The following message Header fields must have the following values:

| | |
|---|---|
| Request Message = | FALSE |
| Response Message = | TRUE |
| Type = | NA/SECESSION |
| Modifier = | NA/SA_ENTRY |
| Message Identifier = | Message Identifier value from request message |

The structure of this message body is described in the following table. The length of the message is set in the Message Length field of the Link Layer section.

TABLE Q
Session Entry Response Frame Structure

| Message Body | Data | Value |
|---|---|---|
| Applicable | U16 | Bit field-each indicated field in the pay- |
| | | load area is related to a bit. If a bit is 1, |
| | | then the sender has a meaningful value |
| | | in the related field. |
| Application | U16/0 | Well known application port number |
| Protocol | | (e.g., HTTP = 80) |
| Source IP Address | U32/1 | IP Address of source |
| Destination IP | U32/2 | IP Address of destination |
| Address | | |
| Real IP Address | U32/3 | IP Address of real server |
| Source Port | U16/4 | Port of source |
| Destination Port | U16/5 | Port of destination |
| Real Port | U16/6 | Port of real server |
| IP Protocol | US/7 | Well known protocol number (e.g., |
| | | tcp = 6, udp = 17) |
| Type | U8/8 | Used to identify the contents of the |
| | | Opaque field |
| Opaque | U8 (64)/ | Field available to application level |
| | 9 | to define additional data |

Example of usage: GPP reads a session table entry from an associated network switch

1. The GPP forms a message with Request Message=TRUE, Response Message=FALSE, Type=Session and Modifier=Read.

2. The GPP sends the request message via NA/SA₁₃ MSG₁₃ SEND₁₃ WITH₁₃ ACK.

3. An SP receives the request message via NA/SA₁₃ MSG₁₃ RECEIVE, which passes it to the Request consumer.

4. The Request consumer reads the entry from the session table.

5. The Request consumer forms a message with Request Message=FALSE, Response Message=TRUE, Type=Session and Modifier=Entry. The Message Identifier in the header of the Response message must equal the Message Identifier in the Request message.

6. The SP sends the Response message via NA/SA₁₃ MSG₁₃ SEND₁₃ WITH₁₃ ACK

7. The GPP receives the Response message via NA/SA₁₃ MSG₁₃ RECEIVE, which notifies the NA/SA higher-level function of success.

14.15 Session Response

The Session Response message is optionally used to acknowledge a Session Create/Update/Delete Request message. If the application requires a response message, then the Request Message flag should be set TRUE in the Session Request message. If the application sets the Request Message flag=FALSE, then the Session Response message is not returned. The following message Header fields must have the following values:

| | |
|---|---|
| Request Message = | FALSE |
| Response Message = | TRUE |
| Type = | NA/SECESSION |
| Modifier = | NA/SA_FEEDBACK |
| Message Identifier = | Message Identifier value from request message |

There is no message body for a Session Response message, therefore the Message Length field of the Link Layer section is always set to length of the message Header.

14.16 System Level Control Messages

This class of interactions deals with messages passed between the network switch and GPP units or between two GPP units. They are operational in nature, enabling the control and setup of each unit. The intent of these interactions is to allow external control of the respective unit, either network switch or GPP. The following subsections will provide details of each interaction.

All System Level Control messages have the same structure; Link Layer section, message Header section followed by the relevant message body. The supported message types are summarized in the following table and details are provided in subsequent sections.

TABLE R
System-Level Control Messages

| Message Type | Message Modifier | Description |
|---|---|---|
| NA/SA_EXCEPTION | 0 | Used to share exception |
| | | details amongst NA/SA |
| | | partners. |
| NA/SA_COMMAND | 0, | Passes a command to a |
| | NA/SA_LOCK_FORCE, | NA/SA partner's CLI. |
| | NA/SA_LOCK_GET, | |
| | NA/SA_LOCK_REL or | |
| | NA/SA_LOCK_QUERY | |
| NA/SA_HEARTBEAT | 0 | Used to determine the |
| | | health of a NA/SA partner |
| NA/SA_REGISTER | NA/SA_GPP or | Used by a GPP to establish |
| | NA/SA_SWITCH | its type, capabilities and |
| | | facilities. The modifier |
| | | value identifies the type of |
| | | NA/SA partner that is |
| | | expected to respond. |
| NA/SA_CAPABILITIES | 0 | This is the response to a |
| | | NA/SA_REGISTER re- |
| | | quest message. It is used to |
| | | establish the sender's type, |
| | | capabilities and facilities. |
| NA/SA_CONFIRM_REGISTRATION | 0 | Used to affirm the com- |
| | | pletion of the registration |
| | | process. This message de- |
| | | clares the facilities, cap- |
| | | abilities and applications |
| | | that will be active through a |
| | | NA/SA tunnel. |
| NA/SA_UNREGISTER | 0 | Used to notify another |
| | | NA/SA entity that the |
| | | sender is disabling the |
| | | previously registered NA/ |
| | | SA functionality |
| NA/SA_CONFIRM_UNREGISTER | 0 | The Unregister Confirm |
| | | message indicates the |
| | | sender has terminated all |
| | | facilities, capabilities and |
| | | applications that had |
| | | previously been registered. |

14.17 NA/SA Exception

The NA/SA Exception message allows NA/SA partners to share details regarding exceptional conditions. The normal handling of this message simply involves the recipient logging the exception in an appropriate manner. The following message Header fields must have the following values:

| Request Message = | FALSE |
|---|---|
| Response Message = | FALSE |
| Type = | NA/SA_EXCEPTION |
| Modifier = | 0 |

The structure of this message body is described in the following table. The length of the message is set in the Message Length field of the Link Layer section.

TABLE S
NA/SA Exception Message Frame Structure

| Message Body | Data | Value |
|---|---|---|
| Exception Message | U8 (12) | The 12-byte NA/SA message Header of |
| Header | | the message that generated the exceptional |
| | | condition |
| Exception Message | U8 (n) | The NA/SA message Body of the message |
| Body | | that generated the exceptional condition. If |
| | | the message Body is greater than 256 |
| | | bytes in length, then this field will contain |
| | | only the first 256 bytes of that message. |

14.18 Command Line Interface

The command message allows a CLI command to be passed to either a network switch or GPP. To address the security concerns regarding this capability, then each unit (network switch or GPP) can be configured to disallow this interaction. If this interaction is allowed, then the command results are passed back to the caller. The following message Header fields must have the following values:

| | |
|---|---|
| Request Message = | TRUE |
| Response Message = | FALSE |
| Type = | NA/SA_COMMAND |
| Modifier = | 0, NA/SA_LOCK_FORCE, |
| | NA/SA_LOCK_GET, |
| | NA/SA_LOCK_REL or |
| | NA/SA_LOCK_QUERY |
| | as described in section 14.19 |

The structure of this message body is described in the following table. The length of the message is set in the Message Length field of the Link-Layer section and is used by the recipient to determine the length of the command. The recipient will convert the command to the required format for internal processing, such as appending null or newline characters at the end of the array.

TABLE T
Command Message Frame Structure

| Message Body | Data | Value |
|---|---|---|
| Command | U8 (n) | The command(s) to be executed |

The results of a command message are returned in a message with a Type of command results. Refer to section 14.11 for an example of the usage of this message.

14.19 Command Lock

There is one NA/SA command lock associated with each NA/SA partner that allows another partner to execute a modifying command(s). A partner must own the lock to execute a modifying command message. The methods for determining which commands are modifying commands are left to the implementation. The Command handler logic will implement the NA/SA command lock.

The NA/SA command lock shall have two states; Owned and Not₁₃ Owned. When the state of the command lock is Owned, then the following information is saved to identify the lock owner:

MAC Address

IP Address

Hold Time

Login Name

When a modifying command message is received, the state of the NA/SA command lock is checked. If the state is Owned and the sender's MAC address matches that of the lock owner, then the command message is executed. If the state of the command lock is not Owned or the sender's MAC address does not match that of the lock owner, then the command message will not be executed and a message with Request Message=FALSE, Response Message=TRUE, Type=command results, Modifier=LOCK₁₃ NOT₁₃ OWNED, Response Code=NA/SA₁₃ ERROR₁₃ CMD₁₃ LOCK₁₃ NOT₁₃ OWNED and a message body as described for Query Command Lock (section 14.22) shall be returned.

14.20 Force Command Lock

The Force Command Lock message requests that the sender be given the recipient's command lock regardless of the current state of the command lock (as long as the Lock IP Address, Lock MAC Address and Lock Login fields of this message match the current values of the command lock). Thus, one GPP can ‘take’ ownership of a network switch's command lock even though another GPP currently is the lock owner. The following message Header fields must have the following values:

| | |
|---|---|
| Request Message = | TRUE |
| Response Message = | FALSE |
| Type = | NA/SA_COMMAND |
| Modifier = | NA/SA_LOCK_FORCE |

The structure of this message body is described in the following table. The length of the message is set in the Message Length field of the Link Layer section.

TABLE U
Force Command Lock Message Frame Structure

| Message Body | Data | Value |
|---|---|---|
| Lock IP Address | U32 | IP address of the current lock owner |
| Lock MAC Address | U8 (6) | MAC address of the current lock owner |
| Lock Login Length | U16 | Length of the login name in the Lock |
| | | Login field |
| Lock Login | U8 (64) | Current login name of the user that will be |
| | | entering modifying commands |
| New IP Address | U32 | IP address of the sender |
| New Hold Time | U16 | New number of seconds that the sender |
| | | expects to hold the command lock |
| New Login Length | U16 | Length of the login name in the New |
| | | Login field |
| New Login | U8 (64) | New login name of the user that will be |
| | | entering modifying commands |

The results of a Force Command Lock message are returned in a message with Request Message=FALSE, Response Message=TRUE, Type=command results, Modifier=NA/SA₁₃ LOCK₁₃ OWNED and a message body as described for Query Command Lock (section 14.22) shall be returned.

14.21 Get Command Lock

A NA/SA partner's command lock must be owned before that partner can execute a modifying command message. The Get Command Lock message requests that the sender be given the recipient's command lock. The following message Header fields must have the following values:

| | |
|---|---|
| Request Message = | TRUE |
| Response Message = | FALSE |
| Type = | NA/SA_COMMAND |
| Modifier = | NA/SA_LOCK_GET |

The structure of this message body is described in the following table. The length of the message is set in the Message Length field of the Link-Layer section.

TABLE V
Get Command Lock Message Frame Structure

| Message Body | Data | Value |
|---|---|---|
| IP Address | U32 | IP address of the sender |
| Hold Time | U16 | Number of seconds that the sender expects |
| | | to hold the command lock |
| Login Length | U16 | Length of the login name in the Login field |
| Login | U8 (64) | Login name of the user that will be entering |
| | | modifying commands |

The results of a Get Command Lock message are returned in a message with Request Message=FALSE, Response Message=TRUE, Type=command results and a message body as described for Query Command Lock (section 14.22). The values of the Modifier and Response Code fields depend on the success of the request. If successful, Modifier=NA/SA₁₃ LOCK₁₃ OWNED and Response Code=NA/SA₁₃ SUCCESS. If failure, Modifier=NA/SA₁₃ LOCK₁₃ NOT₁₃ OWNED and Response Code=NA/SA₁₃ ERROR₁₃ CMD₁₃ LOCK₁₃ NOT₁₃ OWNED.

14.22 Query Command Lock

The Query Command Lock message requests the NA/SA command lock owner information. The following message Header fields must have the following values:

| | |
|---|---|
| Request Message = | TRUE |
| Response Message = | FALSE |
| Type = | NA/SA_COMMAND |
| Modifier = | NA/SA_LOCK_QUERY |

There is no message body for a Query Command Lock message, therefore the Message Length field of the Link Layer section is always set to the length of the message Header.

The results of a Query Command Lock message are returned in a message with Request Message=FALSE, Response Message=TRUE and Type=command results. The value of the Modifier field depends on the current state of the command lock. The structure of this message body is described in the following table. The length of the message is set in the Message Length field of the Link Layer section.

TABLE W
Query Command Lock Message Frame Structure

| Message Body | Data | Value |
|---|---|---|
| IP Address | U32 | IP address of the owner |
| MAC Address | U8 (6) | MAC address of the owner |
| Hold Time | U16 | Number of seconds that the owner expected |
| | | to hold the command lock |
| Held Time | U16 | Number of seconds that the owner has held |
| | | the command lock |
| Login Length | U16 | Length of the login name in the Login field |
| Login | U8 (64) | Login name of the user that will be entering |
| | | modifying commands |

14.23 Release Command Lock

The Release Command Lock message indicates that the NA/SA command lock owner wants to change the state of the command lock to Not₁₃ Owned. The following message Header fields must have the following values:

| | |
|---|---|
| Request Message = | TRUE |
| Response Message = | FALSE |
| Type = | NA/SA_COMMAND |
| Modifier = | NA/SA_LOCK_REL |

There is no message body for a Release Command Lock message, therefore the Message Length field of the Link Layer section is always set to the length of the message Header.

The results of a Release Command Lock message are returned in a message with Request Message=FALSE, Response Message=TRUE, Type=command results and Modifier=NA/SA₁₃ LOCK₁₃ NOT₁₃ OWNED shall be returned.

14.24 Heartbeat Request

The Heartbeat Request message allows a partner to determine the operational status of its partner. It is possible for a GPP to extend its processing of a heartbeat into its application level by passing this message to the application. In that case, the application is expected to form a Heartbeat Response message to be passed back to the Heartbeat Request sender. This allows a network switch to determine the operational status of a GPP based application. If there is not an application to handle the Heartbeat Request message, then the upper NA/SA layer should generate the Heartbeat Response message. The following message Header fields must have the following values:

| Request Message = | TRUE |
|---|---|
| Response Message = | FALSE |
| Type = | NA/SA_HEARTBEAT |
| Modifier = | 0 |

There is no message body for a Heartbeat Request message, therefore the Message Length field of the Link Layer section is always set to the length of the message Header. A Heartbeat Request message is confirmed by a message with a Type of Heartbeat Response.

NA/SA Heartbeat Request messages are always sent best effort.

14.25 NA/SA Registration

NA/SA Registration accomplishes the following functions:

1. Automating the network switch configuration of the GPP. The GPP describes itself in terms of function and capacity. The GPP always initiates the registration process. If two GPPs are registering with each other, then the controlled GPP is responsible for initiating the process.

2. Maximizing the efficiency of the load balancing of each individual GPP. The GPP describes its capacity in terms called capacity units (CU). The switch will subsequently manage the GPP's workload in terms called service units (SU). The capacity metric is used to determine SUs. When the SUs sent to the GPP matches the CU for that GPP, the network switch will consider the GPP to be ‘maxed out.’

3. Allows the network switch (or controlling GPP) to understand the GPP's capabilities. These are functions that can be enabled/disabled on that GPP.

4. Allows the network switch (or controlling GPP) to understand the GPP's facilities. These are functions that are always available on that GPP (those that can't be enabled/disabled).

The following message Header fields must have the following values:

| Request Message = | TRUE |
|---|---|
| Response Message = | FALSE |
| Type = | NA/SA_REGISTER |
| Modifier = | 0 |

The structure of this message body is described in the following table. The length of the message is set in the Message Length field of the Link-Layer section.

NA/SA Registration messages are always sent best effort.

TABLE X
NA/SA Registration Message Frame Structure

| Message | | |
|---|---|---|
| Body Field | Data | |
| Name | Type | Value |
| Requested | U32 | Bit indicating the originator's capabilities (A 1 in |
| Capability | | the bit position indicates that the capability is |
| Vector | | present and is accessible via this API) |
| | | 0-Encryption |
| | | 1-Command Line Interface |
| Requested | U32 | Bit indicating the originator's facilities (A 1 in the |
| Facilities | | bit position indicates that the facility is present |
| | | and is accessible via this API) |
| | | 0-Session Table |
| | | 1-31 TBD (These bits must be zero) |
| Requested | U32 | Bit mask indicating which applications are being |
| Applications | | registered for in this NA/SA message: |
| | | 0-RURL |
| | | 1-Firewall |
| | | 2-SSL |
| | | 3-Akamizer |
| | | 4-30 TBD (These bits must be zero) |
| | | 31-User Defined Application |
| Operational | U8 (6) | The MAC address to send operational messages |
| MAC | | |
| Address | | |
| Initial | U16 | This field contains the initial sequence number, |
| Sequence | | which is used to initialize the NA/SA Link |
| Number | | Layer's Expected Value field. The first |
| | | acknowledged NA/SA control message from the |
| | | sender will use this sequence number. |
| Capacity | U16 | This represents the maximum load that the GPP |
| Units | | can reliably handle |
| Capacity | U16 | A value that indicates the unit of measure for GPP |
| Metric | | capacity. Defined values are: |
| | | NA/SA_CAP_NUM_CONNECTIONS, |
| | | NA/SA_CAP_NUM_PROCESSES |
| Hardware | U8 (32) | Text string containing the model type |
| Identifier | | |
| CLI format | U8 (16) | Text string indicating what format CLI command |
| | | should be issued |
| IP Address | U32 | IP address of sender |
| Netmask | U32 | Network Mask of sender |

14.26 NA/SA Capabilities Response

The following message Header fields must have the following values:

| | |
|---|---|
| Request Message = | FALSE |
| Response Message = | TRUE |
| Type = | NA/SA_CAPABILITIES |
| Modifier = | 0 |
| Message Identifier = | Message Identifier value |
| | from Registration message |

The structure of this message body is described in the following table. The length of the message is set in the Message Length field of the Link Layer section.

NA/SA Capabilities Response messages are always sent best effort.

TABLE Y
NA/SA Capabilities Response Frame Structure

| Message | | |
|---|---|---|
| Body Field | Data | |
| Name | Type | Value |
| Capability | U32 | Indicating which requested capabilities this |
| Bit Mask | | NA/SA entity can support. Note that |
| | | capabilities that were not requested will not |
| | | appear in this message. |
| | | 0-Encryption |
| | | 1-Command Line Interface |
| | | 2-31 TBD (These bits must be zero) |
| Facilities | U32 | Indicating which requested facilities this |
| Bit Mask | | NA/SA entity can support. Note that facilities |
| | | that were not requested will not appear in this |
| | | message. |
| | | 0-Session Table |
| | | 1-31 TBD (These bits must be zero) |
| Applications | U32 | Indicating which requested applications this |
| Bit Mask | | NA/SA entity can support. Note that |
| | | applications that were not requested will not |
| | | appear in this message. |
| | | 0-RURL |
| | | 1-Firewall |
| | | 2-SSL |
| | | 3-Akamizer |
| | | 4-30 TBD (These bits must be zero) |
| | | 31 ? User Defined Application |
| Operational | U8 (6) | The MAC address to send operational messages |
| MAC | | |
| Address | | |
| Initial | U16 | This field contains the initial sequence number, |
| Sequence | | which is used to initialize the NA/SA Link |
| Number | | Layer's Expected Value field. The first |
| | | acknowledged NA/SA control message from |
| | | the sender will use this sequence number. |
| Capacity | U16 | This represents the maximum load that the GPP |
| Units | | can reliably handle |
| Capacity | U16 | A value that indicates the unit of measure for |
| Metric | | GPP capacity. Defined values are: |
| | | NASA_CAP_NUM_CONNECTIONS, |
| | | NASA_CAP_NUM_PROCESSES |
| Hardware | U8 (32) | Text string containing the model type |
| Identifier | | |
| CLI format | U8 (16) | Text string indicating what format CLI |
| Clock | U32 | Current time in absolute ticks |
| Ticks per | U32 | Clock ticks per second |
| second | | |

14.27 NA/SA Registration Confirm

The following message Header fields must have the following values:

| Request Message = | FALSE |
|---|---|
| Response Message = | FALSE |
| Type = | NA/SA_CONFIRM_REGISTRATION |
| Modifier = | 0 |

The structure of this message body is described below. The length of the message is set in the Message Length field of the Link-Layer section. NA/SA Confirm Registration messages are always sent “Ack required.”

The Confirm Register message has no message body; therefore the Message Length field of the Link-Layer section is always set to the length of the message Header.

The registration of a GPP to a Switch proceeds in the following series of events from the GPP's perspective:

1. If the GPP sends a NA/SA₁₃ BCAST₁₃ PING message to discover the MAC addresses of NA/SA capable switches.

2. GPP receives a ping response. GPP sends a best effort NA/SA₁₃ REGISTER message out to the source MAC address of the ping response.

a. Event 1 will be repeated if event 2a does not occur within the pre-defined GPP Registration wait period.

3. GPP receives a NA/SA₁₃ CAPABILITIES message from a switch

a. If Capabilities, Facilities and Applications are sufficient to run desired NA/SA application, proceed to event 3.

b. If Capabilities, Facilities and Applications are not sufficient to run desired NA/SA application, take no action (wait period in event 1a will handle re-transmit)

4. GPP sets up to receive acknowledged messages by using the Initial Sequence Number of the NA/SA₁₃ CAPABILITIES message to initialize the NA/SA Link Layer's Expected Value field.

5. GPP sends an “Ack required” NA/SA₁₃ CONFIRM₁₃ REGISTRATION message to the source MAC address of the NA/SA₁₃ CAPABILITIES message received in event 2. The contents of the Capability Bit Mask, Facilities Bit Mask, and Applications Bit Mask fields of the NA/SA₁₃ CONFIRM₁₃ REGISTRATION shall be the same as the NA/SA₁₃ CAPABILITIES. NA/SA₁₃ CONFIRM₁₃ REGISTRATION messages require acknowledgments.

6. The GPP is now registered to the switch

Note that the same events occur for a GPP registering with another GPP.

From the switch's perspective:

1. Switch receives a NA/SA₁₃ REGISTER message.

a. If port allows NA/SA messages and the message is sent to a broadcast address (or the switch's MAC address), the switch sends a ‘best effort’ NA/SA₁₃ CAPABILITIES message containing the capabilities of this switch. The message is sent to source MAC address of the NA/SA₁₃ REGISTER message in event 1. The values set in the NA/SA₁₃ CAPABILITIES will be stored in the switch. These values will indicate which capabilities, facilities, and applications need to launch when the NA/SA₁₃ CONFIRM₁₃ REGISTER message is received. Proceed to event 2.

b. If the port does not allow NA/SA messages or the destination MAC address is non-broadcast and is not that of the switch, process the frame as a non-NA/SA frame. Take no further action

2. Switch sets up to receive acknowledged messages from the GPP by using the Initial Sequence Number of the NA/SA₁₃ REGISTER message to initialize the NA/SA Link Layer's Expected Value field.

a. If event 3 does not occur within the pre-defined time out period, undo the acknowledged message setup from event 2. Take no further action.

b. If the switch receives another NA/SA₁₃ REGISTER message from the same GPP before event 3 occurs, undo the acknowledged message setup from event 2. Handle the new NA/SA₁₃ REGISTER message again in event 1.

3. Switch receives a NA/SA₁₃ CONFIRM₁₃ REGISTRATION message from the GPP.

a. If the NA/SA₁₃ CONFIRM₁₃ REGISTRATION message is not received within the pre-defined timeout period, the registration information received in event 1 will be discarded. Take no further action.

4. The GPP is now registered to the switch. Any subsequent NA/SA₁₃ REGISTER messages received during the registration process or after the GPP has registered with the switch shall result in the previous registration being undone (including shutting down any applications related to the previous registration) and event 1 of the switch's registration process will handle the new NA/SA₁₃ REGISTER.

Note, that then same events occur for a GPP registering with another GPP. GPP's always initiate the NA/SA registration process. NA/SA registration can operate in 1 of 2 modes: ‘Plug and Play’ and Configured. ‘Plug and Play’ allows a customer to have a NA/SA application function simply by connecting a factory default, NA/SA capable switch and a GPP together. ‘Plug and Play’ has the following restrictions:

The GPP only accepts the first NA/SA₁₃ CAPABILITIES message. Any subsequent NA/SA capabilities frames from other switches will be ignored.

‘Plug and Play’ only works for one switch to many GPP applications. Configured registration allows a customer to configure multi switch to multi GPP applications. For configured registrations, the GPP has the option to send NA/SA₁₃ REGISTER to a user defined MAC address or to a broadcast MAC address (the GPP does not use NA/SA₁₃ BCAST₁₃ PING messages to discover NA/SA switches in configured registrations). The needs of the NA/SA application dictate this decision.

14.28 NA/SA Unregistration

The unregister request message informs the recipient to remove all information about the sender as well as disabling capabilities, facilities, and applications the sender had previously registered for. The following message Header fields must have the following values:

| Request Message = | TRUE or FALSE |
|---|---|
| Response Message = | FALSE |
| Type = | NA/SA_UNREGISTER |
| Modifier = | 0 |

There is no message body for an unregister request message, therefore the Message Length field of the Link Layer section is always set to the length of the message Header.

Unregister messages can be sent in 1 of 2 ways:

1. “Best effort” and Request Message=FALSE. This is used by NA/SA entities that are shutting down immediately (e.g. due to a panic).

2. “Ack required” and Request Message=TRUE. This is used by NA/SA entities that want to cleanly terminate NA/SA activities with another NA/SA entity. This allows the message queue from the sender to the recipient to be completely flushed. This also allows the sender to know when the recipient has completed all appropriate NA/SA unregister activities (e.g. an application encounters an unexpected condition and needs to start over from ground zero).

14.29 NA/SA Unregister Response

The unregister response message is an optional message used to inform the recipient that the sender has completed shutdown of all capabilities, facilities, and applications the recipient had previously registered for. If the Request Message flag=FALSE, then there is no response required for the unregister request message. If the Request Message flag=TRUE, then the unregister response message is generated. The following message Header fields must have the following values:

| | |
|---|---|
| Request Message= | FALSE |
| Response Message = | TRUE |
| Type = | NA/SA_UNREGISTER |
| Modifier = | 0 |
| Message Identifier = | Message Identifier value from unregister request |
| | message |

The unregister response message has no message body, therefore the Message Length field of the Link Layer section is always set to the length of the message Header.

14.30 Table Manipulation

This class of interactions allows external control of data structures within the network switch or GPP. The intent of these interactions is to allow a controller process to anticipate the flow of data and to control that flow when it occurs. The following sections will provide details of each interaction.

14.31 Session Table Manipulation

Clients and servers establish a session (or one is implied) before they communicate. Each session is represented by a row in a session table. This set of messages (create, read, update, or delete session) controls the rows of a session table. The session table normally resides within a network switch, but a similar table can exist within a GPP. These messages can be used to control the contents in either case.

14.32 Session Create

The Create modifier is used to add new entries to the session table. If the Request Message flag=TRUE, then the session response message is returned. If the Request Message flag=FALSE, then there is no response to this message. The following message Header fields must have the following values:

| | |
|---|---|
| Request Message = | TRUE or FALSE |
| Response Message = | FALSE |
| Type = | NA/SECESSION |
| Modifier = | NA/SA_CREATE |

The structure of this message body is described in the following table. The length of the message is set in the Message Length field of the Link Layer section.

TABLE Z
Create Modifier Message Frame Structure

| Message Body | Data Type/ | Value |
|---|---|---|
| Applicable | U16 | Bit field-each indicated field in the |
| | | payload area is related to a bit. If a bit is |
| | | 1, then the sender has a meaningful |
| | | value in the related field. |
| Application | U16/0 | Well known application port number |
| Protocol | | (e.g., HTTP = 80) |
| Source IP | U32/1 | IP Address of source |
| Address | | |
| Destination IP | U32/2 | IP Address of destination |
| Address | | |
| Real IP Address | U32/3 | IP Address of real server |
| Source Port | U16/4 | Port of source |
| Destination Port | U16/5 | Port of destination |
| Real Port | U16/6 | Port of real server |
| IP Protocol | U8/7 | Well known protocol number (e.g., |
| | | tcp = 6, udp = 17) |
| Type | U8/8 | Used to identify the contents of the |
| | | Opaque field |
| Opaque | U8 (64)/9 | Field available to application level |
| | | to define additional data |

14.33 Session Read

The Read modifier is used to read rows from the session table. The results of a Read Session request message are returned in a message with a Type of Session Entry. Refer to section 4.6.4 for an example of reading a session entry.

The following message Header fields must have the following values:

| | |
|---|---|
| Request Message = | TRUE |
| Response Message = | FALSE |
| Type = | NA/SECESSION |
| Modifier = | NA/SA_READ |

The structure of this message body is described in the following table. The length of the message is set in the Message Length field of the Link-Layer section.

TABLE AA
Read Modifier Frame Structure

| | Data | |
|---|---|---|
| | Type/ | |
| Message Body | Applicable | |
| Field Name | bit | Value |
| Applicable | U16 | Bit field-each indicated field in the pay- |
| | | load area is related to a bit. If a bit is 1, |
| | | then the sender has a meaningful value |
| | | in the related field. |
| Application | U16/0 | Well known application port number |
| Protocol | | (e.g., HTTP = 80) |
| Source IP Address | U32/1 | IP Address of source |
| Destination IP | U32/2 | IP Address of destination |
| Address | | |
| Real IP Address | U32/3 | IP Address of real server |
| Source Port | U16/4 | Port of source |
| Destination Port | U16/5 | Port of destination |
| Real Port | U16/6 | Port of real server |
| IP Protocol | U8/7 | Well known protocol number (e.g., |
| | | tcp = 6, udp = 17) |
| Type | U8/8 | Used to identify the contents of the |
| | | Opaque field |
| Opaque | U8 (64)/9 | Field available to application level to |
| | | define additional data |

14.34 Session Update

The Update modifier uses the values in the Tbl fields to identify the session being referenced for update. Once the session has been identified, then it is updated with the values from the New fields. The Applicable bit field conditions the handling of both the Tbl and New fields. If the Request Message flag=TRUE, then the session response message is returned. If the Request Message flag=FALSE, then there is no response to this message. The following message Header fields must have the following values:

| | |
|---|---|
| Request Message = | TRUE or FALSE |
| Response Message = | FALSE |
| Type = | NA/SECESSION |
| Modifier = | NA/SA_UPDATE |

The structure of this message body is described in the following table. The length of the message is set in the Message Length field of the Link Layer section.

TABLE BB
Session Update Modifier Frame Structure

| | Data Type/ | |
|---|---|---|
| Message Body | Applicable | |
| Field Name | bit | Value |
| Applicable | U16 | Bit field-each indicated field in the pay- |
| | | load area is related to a bit. If a bit is 1, |
| | | then the sender has a meaningful value |
| | | in the related field. |
| Tbl Application | U16/0 | Session Table-Well known application |
| Protocol | | port number (e.g., HTTP = 80) |
| Tbl Source IP | U32/1 | Session Table-IP Address of source |
| Address | | |
| Tbl Destination | U32/2 | Session Table-IP Address of destination |
| IP Address | | |
| Tbl Source Port | U16/3 | Session Table-Port of source |
| Tbl Destination | U16/4 | Session Table-Port of destination |
| Port | | |
| Tbl IP Protocol | U8/5 | Session Table-Well known protocol |
| | | number (e.g., tcp = 6, udp = 17) |
| New IP Protocol | U8 6 | Well known protocol number (e.g., |
| | | tcp = 6, udp = 17) |
| New Application | U16/7 | Well known application port number |
| Protocol | | (e.g., HTTP = 80) |
| New. Source IP | U32/8 | IP Address of source |
| Address | | |
| New Destination | U32/9 | IP Address of destination |
| IP Address | | |
| New Source Port | U16/10 | Port of source |
| New Destination | U16/11 | Port of destination |
| Port | | |
| Type | U8/12 | Used to identify the contents of the |
| | | Opaque field |
| Opaque | U8 (64)/13 | Field available to application level to |
| | | define additional data |

14.35 Session Delete

The Delete modifier is used to delete entries from the session table. The values in the Applicable fields identify the session to be deleted. If the Request Message flag=TRUE, then the session response message is returned. If the Request Message flag=FALSE, then there is no response to this message. The following message Header fields must have the following values:

| | |
|---|---|
| Request Message = | TRUE or FALSE |
| Response Message = | FALSE |
| Type = | NA/SECESSION |
| Modifier = | NA/SA_DELETE |

The structure of this message body is described in the following table. The length of the message is set in the Message Length field of the Link Layer section.

TABLE CC
Session Delete Modifier Frame Structure

| | Data Type/ | |
|---|---|---|
| Message Body | Applicable | |
| Field Name | bit | Value |
| Applicable | U16 | Bit field-each indicated field in the pay- |
| | | load area is related to a bit. If a bit is 1, |
| | | then the sender has a meaningful value |
| | | in the related field. |
| Application | U16/0 | Well known application port number |
| Protocol | | (e.g., HTTP = 80) |
| Source IP | U32/1 | IP Address of source |
| Address | | |
| Destination IP | U32/2 | IP Address of destination |
| Address | | |
| Real IP Address | U32/3 | IP Address of real server |
| Source Port | U16/4 | Port of source |
| Destination Port | U16/5 | Port of destination |
| Real Port | U16/6 | Port of real server |
| IP Protocol | U8/7 | Well known protocol number (e.g., |
| | | tcp = 6, udp = 17) |
| Type | U8/8 | Used to identify the contents of the |
| | | Opaque field |
| Opaque | U8 (64)/9 | Field available to application level to |
| | | define additional data |

14.36 Session Characteristics Request

The Session Characteristics Request message is used to determine a number of attributes of the session table. Refer to section 14.13 for an example of using the Session Characteristics message. The following message Header fields must have the following values:

| | |
|---|---|
| Request Message = | TRUE |
| Response Message = | FALSE |
| Type = | NA/SECESSION |
| Modifier = | NA/SA_CHARACTERISTICS |

There is no message body for a Session Characteristics Request message, therefore the Message Length field of the Link Layer section is always set to the length of the message Header. A Session Characteristics Request message is confirmed by a message with Request Message=FALSE, Response Message=TRUE, Type=NA/SECESSION and Modifier of Session Characteristics

15. NA/SA Broadcast Tunnel

The NA/SA broadcast tunnel is used to pass NA/SA messages amongst partners. This tunnel is used in conjunction with the NA/SA control tunnel. These two tunnels have the same structure for messages, Link Layer and Header sections followed by the message body. They also share the same message transport except that the broadcast tunnel only uses NA/SA₁₃ MSG₁₃ SEND since all messages sent over the broadcast tunnel are sent best effort.

A NA/SA message is comprised of sections. The Link Layer section is required to be the first section of every NA/SA message. The message Header section follows the Link Layer section and is required in every NA/SA message. The message body follows the Header section. The contents of the message body are dependent on the value of the Type field of the message Header. Some message types do not have a message body.

TABLE DD
NA/SA Broadcast Messages

| Message Type | Message Modifier | Description |
|---|---|---|
| NA/SA_BCAST_GENERAL | 0, NA/SA_GPP or | Used to send broadcast |
| | NA/SA_SWITCH | messages to the targeted |
| | | classes of partners |
| | | (GPP or network switch) |
| NA/SA_BCAST_IP_ADDRESS | 0 | Used by GPP to re- |
| | | quest that an IP |
| | | address be assigned to it |
| NA/SA_BCAST_PING | 0, NA/SA_GPP or | Used to determine |
| | NA/SA_SWITCH | whether NA/SA |
| | | partners are available |
| NA/SA_UCAST_GENERAL | 0 | Used to send a message in |
| | | response to a broadcast |
| | | request message |
| NA/SA_UCAST_IP_ADDRESS | 0 | Provides an IP address |
| | | to the requestor |
| NA/SA_UCAST_PING_ANSWER | 0 | Provides feedback |
| | | regarding a ping |
| | | request. |

15.1 Broadcast General

The NA/SA Broadcast General message allows one partner to send messages to the rest of the accessible NA/SA partners. The Request Message flag indicates the sender's expectation regarding a response message. If Request Message=TRUE, then at least one General Response messages is expected. If Request Message=FALSE, then no response messages are expected. The Modifier value indicates the target class. Zero indicates all NA/SA partners. NA/SA₁₃ GPP indicates that all GPPs are the intended target. NA/SA₁₃ SWITCH indicates that all network switches are the intended target. The following message Header fields must have the following values:

| | |
|---|---|
| Request Message = | TRUE or FALSE |
| Response Message = | FALSE |
| Type = | NA/SA_BCAST_GENERAL |
| Modifier = | 0, NA/SA_GPP or NA/SA_SWITCH indicating |
| | the type of partner that the sender is intending to |
| | receive this message |

The structure of this message body is described in the following table. The length of the message is set in the Message Length field of the Link-Layer section.

TABLE EE
Broadcast General Message Frame Structure

| Message Body Field | | |
|---|---|---|
| Name | Data Type | Value |
| Type | U32 | Used to identify the contents of the |
| | | Opaque field |
| Opaque | U8 (n) | An opaque field that is generated by the |
| | | sender and that may be understood by |
| | | each recipient. |

Note that the NA/SA Broadcast General message is sent to the broadcast address. There is no acknowledgment available for this message. This message is always sent best effort.

15.2 IP Address Request

The IP Address Request message is used by a GPP to request that an IP address be assigned to it. It is expected that the user when installing the first GPP can assign a block of IP addresses. This message is used by subsequent GPPs to request an IP address from that block of addresses. It is the responsibility of the GPP application that receives this message to generate the IP Address Response message. The following message Header fields must have the following values:

| Request Message = | TRUE |
|---|---|
| Response Message = | FALSE |
| Type = | NA/SA_BCAST_IP_ADDRESS |
| Modifier = | 0 |

There is no message body for an IP Address Request message, therefore the Message Length field of the Link Layer section is always set to the length of the message Header. The results of an IP Address Request message are returned in a message with a Type of IP Address Response.

NA/SA IP Address Request messages are always sent best effort and are always addressed to the broadcast destination.

15.3 Ping Broadcast

The Ping Broadcast message is used to locate NA/SA partners. The following message Header fields must have the following values:

| | |
|---|---|
| Request Message = | TRUE |
| Response Message = | FALSE |
| Type = | NA/SA_BCAST_PING |
| Modifier = | 0, NA/SA_GPP or NA/SA_SWITCH indicating |
| | the type of partner that the sender is looking for. |

The structure of this message body is described in the following table. The length of the message is set in the Message Length field of the Link Layer section. The recipient will compare its MAC address with the Ignore List to determine if a response is required.

TABLE FF
Ping Broadcast Message Frame Structure

| Message Body Field | Data | |
|---|---|---|
| Name | Type | Value |
| List Length | U16 | The number of elements in the Ignore List |
| Ignore List | U6 (n) | The MAC addresses of NA/SA partners |
| | | that should not respond to this request |

The results of a Ping Broadcast message are returned in a message with a Type of Ping Answer. NA/SA Ping Broadcast messages are always sent best effort and are always addressed to the broadcast destination.

15.4 General Response

The NA/SA General Response message allows a partner to response to a General Request message. The following message Header fields must have the following values:

| | |
|---|---|
| Request Message = | FALSE |
| Response Message = | TRUE |
| Type = | NA/SA_UCAST_GENERAL |
| Modifier = | 0 |
| Message Identifier = | Message Identifier value from General Request |
| | message |

The structure of this message body is described in the following table. The length of the message is set in the Message Length field of the Link Layer section.

TABLE GG
General Response Message Frame Structure

| Message Body Field | Data | |
|---|---|---|
| Name | Type | Value |
| Sequence Number | U32 | A field that allows an application to |
| | | indicate the order of a multi-message |
| | | response to the requestor so that the |
| | | requestor can re-construct the entire |
| | | response. |
| Type | U32 | Used to identify the contents of the |
| | | Opaque field |
| Opaque | U8 (n) | An opaque field that is generated by the |
| | | sender and that may be understood by |
| | | each recipient. |

Note that the NA/SA General Response message is sent to a specific MAC address. There is no acknowledgment available for the General Response message. This message is always sent best effort. If this is a multi-message response, then the sender can indicate message order by the Sequence Number field and the last message is indicated by Response Code=NA/SA₁₃ SUCCESS₁₃ LAST.

15.5 IP Address Response

The IP Address Response message is used to assign an IP address to a GPP that requested one. A GPP requests an IP address by sending an IP Address Request broadcast message. The GPP application that receives the IP Address Request message is responsible for generating the IP Address Response message. The following message Header fields must have the following values:

| | |
|---|---|
| Request Message = | FALSE |
| Response Message = | TRUE |
| Type = | NA/SA_UCAST_IP_ADDRESS |
| Modifier = | 0 |
| Message Identifier = | Message Identifier value from IP Address Request |
| | message |

The structure of this message body is described in the following table. The length of the message is set in the Message Length field of the Link Layer section.

TABLE HH
IP Address Response Message Frame Structure

| Message Body Field | Data | |
|---|---|---|
| Name | Type | Value |
| IP Address | U32 | IP address that is assigned to the requestor |

NA/SA IP Address Response messages are always sent best effort and are always addressed to the MAC address of the sender of the IP Address Request message.

15.6 Ping Answer

The Ping Answer message is used to return the results of a Ping Broadcast message. The following message Header fields must have the following values:

| | |
|---|---|
| Request Message = | FALSE |
| Response Message = | TRUE |
| Type = | NA/SA_UCAST_PING_ANSWER |
| Modifier = | 0 |
| Message Identifier = | Message Identifier value from Ping Broadcast |
| | message |

There is no message body for a Ping Answer message, therefore the Message Length field of the Link Layer section is always set to the length of the message Header.

NA/SA Ping Answer messages are always sent best effort and are always addressed to the MAC address of the sender of the Ping Broadcast message.

### SUMMARIES

TABLE II
Message Type Summary

| Message Type | Message Modifier | Description |
|---|---|---|
| NA/SA_BCAST | 0, NA/SA_GPP or | Used to send each |
| GENERAL | NA/SA_SWITCH | NA/SA partner a |
| | | message. |
| NA/SA_BCAST_IP | 0 | Used by GPP tp request an IP |
| ADDRESS | | address be assigned to it. |
| NA/SA_BCAST_PING | 0, NA/SA_GPP or | Used to determine if |
| | NA/SA_SWITCH | NA/SA partners are available. |
| NA/SA_CAPABILITIES | 0 | Response to a regis- |
| | | tration request. De- |
| | | scribes the respondents |
| | | processing capabilities. |
| NA/SA_CMD_RESULTS | NA/SA_LOCK_OWNED or | Used to return the re- |
| | NA/SA_LOCK_NOT_OWNED | suits of a CLI command. |
| NA/SA_COMMAND | 0, NA/SA_LOCK_FORCE, | Used to pass CLI com- |
| | | hands to another unit. |
| | NA/SA_LOCK_GET | Response message is |
| | | returned that contains |
| | | the command response |
| | | text. |
| NA/SA_CONFIRM_REGISTRATION | 0 | Ends the registration |
| | | process between NA/SA |
| | | partners. |
| NA/SA_EXCEPTION | 0 | Used to convey details |
| | | of exceptions among |
| | | NA/SA partners. |
| NA/SA_HEARTBEAT | 0 | Identifies operational |
| | | status of sender. |
| NA/SA_HEARTBEAT | 0 | Heartbeat Response |
| | | acknowledges Heartbeat |
| | | Message |
| NA/SA_REGISTER | 0 | Identifies a GPP or |
| | | switch and its |
| | | capabilities. Starts |
| | | negotiations of the |
| | | manner in which |
| | | subsequent processing |
| | | will occur. |
| NA/SECESSION | NA/SA_CHARACTERISTICS | Used to request |
| | | attributes of the session |
| | | table. |
| NA/SECESSION | NA/SA_CHARACTERISTICS | Returns attributes of the |
| | | session table. |
| NA/SA_SESSION | NA/SA_CREATE | Adds entry to the |
| | | sessikons table. |
| NA/SA_SESSION | NA/SA_DELETE | Deletes an entry from |
| | | the sessions table. |
| NA/SA_SESSION | NA/SA_ENTRY | Returns values for a |
| | | specific session entry. |
| NA/SA_SESSION | NA/SA_FEEDBACK | Optionally provides a |
| | | response message to |
| | | create/delete/update |
| | | messages. |
| NA/SA_SESSION | NA/SA_READ | Reads an entry from the |
| | | sessions trable. |
| NA/SA_SESSION | NA/SA_UPDATE | Updates an entry in the |
| | | sessions table. |
| NA/SA_UCAST_GENERAL | 0 | Responds to a Broadcast |
| | | General message. |
| NA/SA_UCST_IP_ADDRESS | 0 | Provides an IP address |
| | | to a requestor. |
| NA/SA_UCAST_PING_ANSWR | 0 | Provides feedback to a |
| | | Ping request. |
| NA/SA_UNREGISTER | 0 | Notifies another NA/SA |
| | | entity the sender is |
| | | disabling the previous |
| | | NA/SA functionality. |
| NA/SA_UNREGISTER_CONFIRM | 0 | Indicates the sender has |
| | | terminated all facilities, |
| | | capabilities previously |
| | | registered. |

### Error Numbers

The following table lists the valid error numbers that can be used to report problems that occur during the processing of a NA/SA control message. The Response Code field of the message header section provides feedback to the requestor when an error is encountered. This table listed the valid values that the Response Code field can contain.

TABLE JJ
Error Numbers

| Label | Description |
|---|---|
| NASA_ERROR_CLI_DISABLED | A Command message has failed since the |
| | CLI interface is not enabled. |
| NASA_ERROR_CLI_FAIL | A command message has failed during |
| | command processing. |
| NASA_ERROR_CMD_LOCK_NOT_OWNED | A modifying Command message has been |
| | received, but the sender does not hold the |
| | command lock. |
| NASA_ERROR_INVALID_APPL_PROTOCOL | A message refers to an application protocol, |
| | but the value provided is not valid. |
| NASA_ERROR_INVALID_IP_PROTOCOL | A message refers to an IP protocol, but the |
| | value provided is not valid. |
| NASA_ERROR_INVALID_MESSAGE_MODIFIER | A message header section Modifier field |
| | contains an unsupported value or contains a |
| | supported value that is not defined to be used |
| | with the value specified in the Type field. |
| NASA_ERROR_INVALID_MESSAGE_TYPE | A message header section type field contains |
| | an unsupported value. |
| NASA_ERROR_MISSING_IP_ADDRESS | A message header section Type field implies |
| | the presence of an IP address, but it has not |
| | been provided or has a value of zero. |
| NASA_ERROR_MISSING_PORT_NUMBER | A message header section Type field implies |
| | the presence of a Port Number, but it has not |
| | been provided or has a value of zero. |
| NASA_ERROR_SESSION_NOT_UNIQUE | A message header section Type field refers |
| | to a session but the values provided do not |
| | resolve to a unique session entry. |

### Exception Numbers

The following table lists the valid exception numbers that can be used to report problems that occur during the delivery of a NA/SA control message. In these situations, a NASA_EXCEPTION message is formed with the Response Code field of the message header section providing feedback. This table listed the valid values that the Response Code field can contain.

TABLE KK
Exception Numbers

| Label | Description |
|---|---|
| NASA_EXCEPTION_SEQUENCE | A message has been received with |
| | ACK Required set true and the |
| | Sequence Number field does not |
| | contain the expected value. |
| NASA_EXCEPTION_UNEXPECTED_HEADER_VERSION | A message header section Header |
| | Version field contains a value that |
| | is not supported. |
| NASA_EXCEPTION_UNSUPPORTED_ENCRYPTION | A message header section Security |
| | Type field contains a value that is |
| | not supported. |

### Success Numbers

The following table lists the numbers that can be used to report success of a NA/SA control message The Response Code field of the message header section provides feedback to the requester when message processing has completed. This table listed the valid values that the Response Code field can contain.

TABLE LL
Success Numbers

| Label | Description |
|---|---|
| NASA SUCCESS | A message has successfully |
| | completed. |
| NASA SUCCESS LAST | This is the last response message for |
| | a multi-message response. |
| NASA CLI STATUS | The CLI command completed with |
| | unusual conditions. |

### Conclusion

Although the present invention has been described in detail with reference to particular preferred and alternate embodiments, persons possessing ordinary skill in the art to which this invention pertains will appreciate that various modifications and enhancements maybe made without departing from the spirit and scope of the claims that follow. The various configurations that have been disclosed above are intended to educate the reader about preferred and alternative embodiments, and are not intended to constrain the limits of the invention or the scope of the claims. The list of Reference Characters which follows is intended to provide the reader with a convenient means of identifying elements of the invention in the Specification and Drawings. This list is not intended to delineate or narrow the scope of the claims.

What is claimed is:

1. An apparatus comprising:
a first networking means (52) for receiving a flow of data (60) from a network (20, 22), processing said data and delivering processed said data (60) to said network (20, 22);
a second networking means (54) for inspecting received said data (60) and for making decisions in respect of received said data (60);
said first networking means (52) being coupled to said second networking means (54) by a plurality of tunnels (56, 58, 70); a flow of data (60) received by said first networking means (52) being passed to said second networking means (54) through a first one of said plurality of tunnels (56, 58, 70) and redirected to said first networking means by a second one of said plurality of tunnels (56, 58, 70);
said second networking means (54) exercising operational control of said first networking means (52) by sending messages to said first networking means (52) through a third one of said plurality of tunnels (56, 58, 70) and receiving replies from said first networking means (52) through a fourth one of said plurality of tunnels (56, 58, 70); and said messages including instructions to start, stop and “boot” said first networking means and to start, stop and otherwise direct said flow of data (60) through said first networking means.

2. An apparatus as claimed in claim 1, in which an interface is provided between said first networking means (52) and said second networking means (54).

3. An apparatus as claimed in claim 1, in which said first networking means (52) includes a general purpose processor (GPP) (16).

4. An apparatus as claimed in claim 1, in which said second networking means (54) includes an Ethernet™ web switch (14).

5. An apparatus as claimed in claim 1, in which said first networking means (52) can control said second networking means (54).

6. An apparatus as claimed in claim 1, in which said first networking means (52) is optimized for high-speed data transfer.

7. An apparatus as claimed in claim 1, in which said second networking means (54) is attached to said first networking means (52), and can access packets only if they flow through said first networking means (52).

8. An apparatus as claimed in claim 1, in which said second networking means (54) can only send packets to said network (20, 22) if they flow through said first networking means (52).

9. An apparatus as claimed in claim 1, in which second networking means (54) is optimized for data inspection, and for associated data flow decision making.

10. An apparatus as claimed in claim 1, in which network processing occurs in a network switch (14).

11. An apparatus as claimed in claim 1, in which application processing occurs in a general purpose processor (16).

12. An apparatus as claimed in claim 1, in which one of said tunnels (56, 58, 70) is a Control tunnel that is used to control the operation of a first device by a second device.

13. An apparatus as claimed in claim 1, in which one of said tunnels (56, 58, 70) is a Broadcast tunnel which is connected to all network devices.

14. An apparatus as claimed in claim 1, in which one of said tunnels (56, 58, 70) is a Data tunnel which is used to pass network data a packets between network devices.

15. An apparatus as claimed in claim 1, which is used as a virus checker.

16. An apparatus as claimed in claim 1, which is used to block the illegal transfer of copyrighted files.

17. An apparatus as claimed in claim 1, which is used to block illegal file-sharing.

18. An apparatus as claimed in claim 1, which is used to block intentional denial-Of-service schemes.

19. An apparatus as claimed in claim 1, which utilizes data flow acceleration.

20. An apparatus as claimed in claim 1, in which decisions made by said first networking means (52) affect the operation of said second networking means (54).

21. An apparatus as claimed in claim 1, in which decisions made by said second networking means (54) affect the operation of said first networking means (52).
